(19) United States
(12) Patent Application Publication
(10) Pub. No.: US 2023/0071008 A1
(43) Pub. Date: Mar. 9, 2023

(54) COMPUTER-READABLE, NON-TRANSITORY RECORDING MEDIUM CONTAINING THEREIN IMAGE PROCESSING PROGRAM FOR GENERATING LEARNING DATA OF CHARACTER DETECTION MODEL, AND IMAGE PROCESSING APPARATUS

(71) Applicant: KYOCERA Document Solutions Inc., Osaka (JP)

(72) Inventors: Kazuki DOZEN, Osaka (JP); Yukio IWASAKI, Osaka (JP); Atsushi SUZUKI, Osaka (JP); Shunsuke MORI, Osaka (JP); Takuma FUJITA, Osaka (JP)

(73) Assignee: KYOCERA Document Solutions Inc., Osaka (JP)

(21) Appl. No.: 17/900,915

(22) Filed: Sep. 1, 2022

(30) Foreign Application Priority Data
Sep. 3, 2021 (JP) 2021-144053

(51) Int. Cl. G06V 10/774; G06V 10/26; G06V 30/148; G06V 30/14

(52) U.S. Cl. CPC G06V 10/774; G06V 10/26; G06V 30/148; G06V 30/1444

(57) ABSTRACT

A computer-readable, non-transitory recording medium contains therein an image processing program. The image processing program is for generating learning data of a character detection model that at least detects, to recognize a character in a document contained in an image, a position of the character in the image, and configured to cause a computer to generate a cropped image by cropping the image, and adopt the cropped image not containing an image representing a split character as the learning data, instead of adopting the cropped image containing the image representing the split character as the learning data.

### INCORPORATION BY REFERENCE

This application claims priority to Japanese Patent Application No. 2021-144053 filed on Sep. 3, 2021, the entire contents of which are incorporated by reference herein.

### BACKGROUND

The present disclosure relates to a computer-readable, non-transitory recording medium, containing therein an image processing program for generating learning data of a character detection model, and to an image processing apparatus.

Techniques to recognize characters in a document contained in an image are known.

### SUMMARY

The disclosure proposes further improvement of the foregoing techniques.

In an aspect, the disclosure provides a computer-readable, non-transitory recording medium having an image processing program stored therein. The image processing program is for generating learning data of a character detection model that at least detects, to recognize a character in a document contained in an image, a position of the character in the image, and configured to cause a computer to generate a cropped image by cropping the image, and adopt the cropped image not containing an image representing a split character as the learning data, instead of adopting the cropped image containing the image representing the split character as the learning data.

In another aspect, the disclosure provides an image processing apparatus that generates learning data of a character detection model that at least detects, to recognize a character in a document contained in an image, a position of the character in the image. The image processing apparatus includes a control device including a processor, and configured to generate, when the processor executes an image processing program, a cropped image by cropping the image, and adopt the cropped image not containing an image representing a split character as the learning data, instead of adopting the cropped image containing the image representing the split character as the learning data.

### BRIEF DESCRIPTION OF THE DRAWINGS

FIG. 1 is a block diagram showing a configuration of an image processing apparatus according to an embodiment of the disclosure, constituted of a single computer;

FIG. 2 is a flowchart showing an OCR process executed by the image processing apparatus shown in FIG. 1;

FIG. 3A is a schematic drawing showing an example of a digitized image, acquired through the image acquisition process shown in FIG. 2;

FIG. 3B is a schematic drawing showing an example of a layout of characters detected through the character detection process shown in FIG. 2;

FIG. 3C is a schematic drawing showing an example of positions of lines detected through the line detection process shown in FIG. 2;

FIG. 4A is a schematic drawing showing an example of the characters recognized through the character recognition process shown in FIG. 2;

FIG. 4B is a schematic drawing showing an example of the character string of each line identified through the character recognition process shown in FIG. 2;

FIG. 5A is a schematic drawing showing an example of learning data used for learning of the hand-written pixel detection model shown in FIG. 1;

FIG. 5B is a schematic drawing showing an example of right answer data used for the learning of the hand-written character detection shown in FIG. 1;

FIG. 6 is a flowchart showing a blur correction process executed by the image processing apparatus shown in FIG. 1;

FIG. 7A is a schematic drawing showing an example of a digitized image, before detection of pixels by the blur correction device shown in FIG. 1;

FIG. 7B is a schematic drawing showing an example of the pixels detected by the blur correction device shown in FIG. 1;

FIG. 8 is a schematic drawing showing an example of the digitized image, formed after a blurred character has been corrected through the blur correction process shown in FIG. 2;

FIG. 9 is a flowchart showing an operation executed by the image processing apparatus shown in FIG. 1, for the learning of the character detection;

FIG. 10 is a schematic drawing showing an example of a digitized image prepared for the learning of the character detection shown in FIG. 1;

FIG. 11 is a schematic drawing showing an example of a cropped image, generated through the operation shown in FIG. 9; and

FIG. 12 is a schematic drawing showing an example of a corrected cropped image, generated through the operation shown in FIG. 9.

### DETAILED DESCRIPTION

Hereafter, an image processing program, a computer-readable, non-transitory recording medium having the image processing program stored therein, and an image processing apparatus according to an embodiment of the disclosure will be described, with reference to the drawings. The image processing program is designed to generate learning data of a character detection model.

First, a configuration of the image processing apparatus according to the embodiment of the disclosure will be described.

The image processing apparatus according to this embodiment may be constituted of a single computer, such as an image forming apparatus configured as a multifunction peripheral (MFP), or a personal computer (PC), or of a plurality of computers.

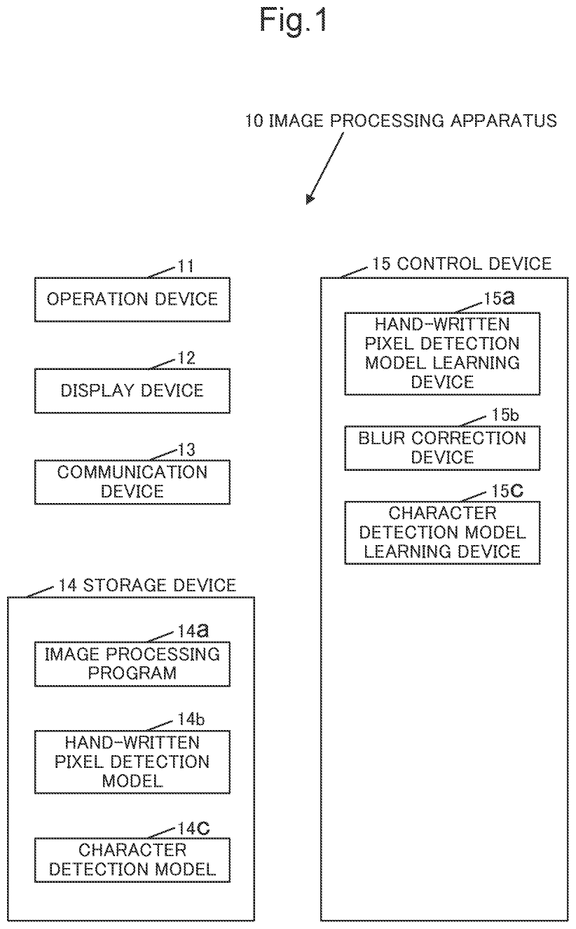

FIG. 1 is a block diagram showing a configuration of the image processing apparatus 10, constituted of a single computer.

As shown in FIG. 1, the image processing apparatus 10 includes an operation device 11 including a keyboard, a mouse, and so forth, and for inputting various types of information, a display device 12, for example including a liquid crystal display (LCD), for displaying various types of information, a communication device 13 that makes wired or wireless communication with an external device, directly or via a network such as a local area network (LAN) or the internet, a storage device 14 constituted of a non-volatile memory unit such as a semiconductor memory or a hard disk drive (HDD), for storing various types of information, and a control device 15 that controls the overall operation of the image processing apparatus 10.

The storage device 14 contains an image processing program 14a according to the embodiment of the disclosure. The image processing program 14a may be installed in the image processing apparatus 10, for example during the manufacturing process thereof, or additionally installed in the image processing apparatus 10 from an external storage medium such as a universal serial bus (USB) memory, or from a network. For example, the image processing program 14a may be stored in the computer-readable, non-transitory recording medium.

The storage device 14 also contains a hand-written pixel detection model 14b, serving as a module that detects a pixel of a hand-written line by extrapolation, in a blur correction process 21b. The hand-written pixel detection model 14b executes a machine learning method, for example based on the U-Net.

The storage device 14 further contains a character detection model 14c, serving as a module for executing a character detection process 22a.

The control device 15 includes, for example, a central processing unit (CPU), a read-only memory (ROM) containing programs and various types of data, and a random-access memory (RAM) used as the operation region for the CPU of the control device 15. The CPU of the control device 15 acts as the processor that executes the programs stored in the storage device 14 or the ROM of the control device 15.

The control device 15 realizes, by executing the image processing program 14a, a hand-written pixel detection model learning device 15a that learns the hand-written pixel detection model 14b, a blur correction device 15b that executes the blur correction process 21b, a character detection model learning device 15c that learns the character detection model 14c, and an OCR device 15d.

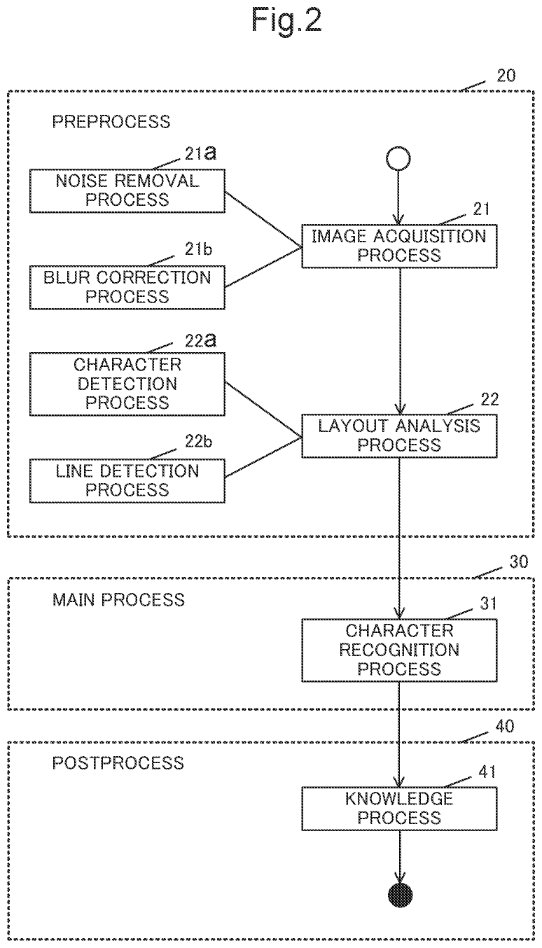

FIG. 2 is a flowchart showing an optical character recognition (OCR) process executed by the image processing apparatus 10.

The control device 15 acts as the OCR device 15d by executing the image processing program 14a, thereby executing the operation shown in FIG. 2.

As shown in FIG. 2, the OCR process executed by the image processing apparatus 10 includes a main process 30 which is the main part of the OCR technique, a preprocess 20 executed before the main process 30, and a postprocess 40 executed after the main process 30.

The preprocess 20 includes an image acquisition process 21 executed with respect to an image digitized from a document written on a medium such as a paper sheet, by a device such as a scanner or a camera (hereinafter, “digitized image”), and a layout analysis process 22 for analyzing the layout of characters and lines in the document contained in the digitized image.

The image acquisition process 21 includes a noise removal process 21a for correcting the shape of the digitized image to improve the accuracy of the character recognition, such as keystone correction and orientation correction of the digitized image, and removing, to improve the accuracy of the character recognition, the information unnecessary for the character recognition, such as halftone dot meshing contained in the digitized image, or shadow that has intruded in the digitized image during the digitization process. The image acquisition process 21 also includes a blur correction process 21b for correcting a blurred line contained in the digitized image that has undergone the noise removal process 21a. For example, the blurred line appears in the digitized image, when hand-written characters written with a low writing pressure are digitized.

Although the blur correction process 21b is executed after the noise removal process 21a in this embodiment, the blur correction process 21b may be executed at a different timing. For example, the blur correction process 21b may be executed while the noise removal process 21a is being executed, or before the noise removal process 21a is executed.

In the layout analysis process 22, the layout of the document, contained in the digitized image that has undergone the noise removal process 21a and the blur correction process 21b, is analyzed. The layout analysis process 22 includes a character detection process 22a, including detecting the characters in the document contained in the digitized image, and the positions of the respective characters in the digitized image, and a line detection process 22b including detecting the position of a line constituted of the characters detected through the character detection process 22a, in the digitized image.

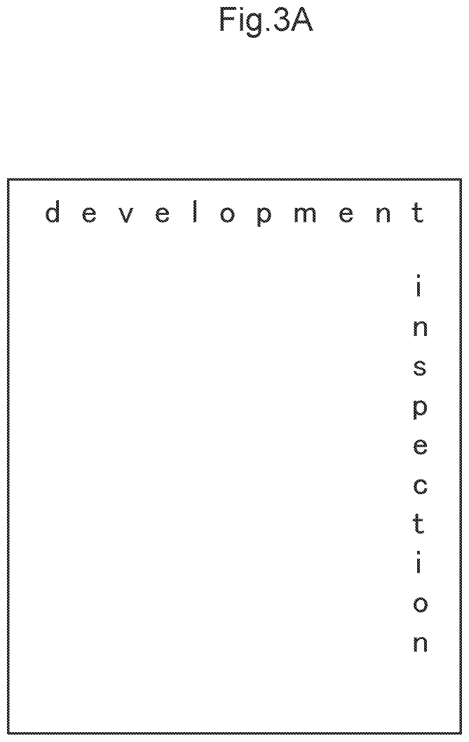

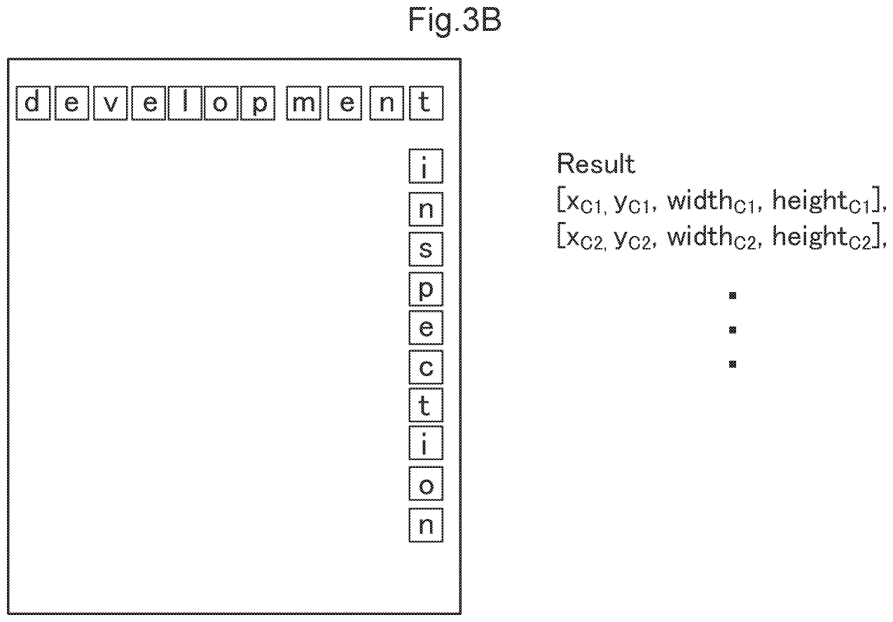

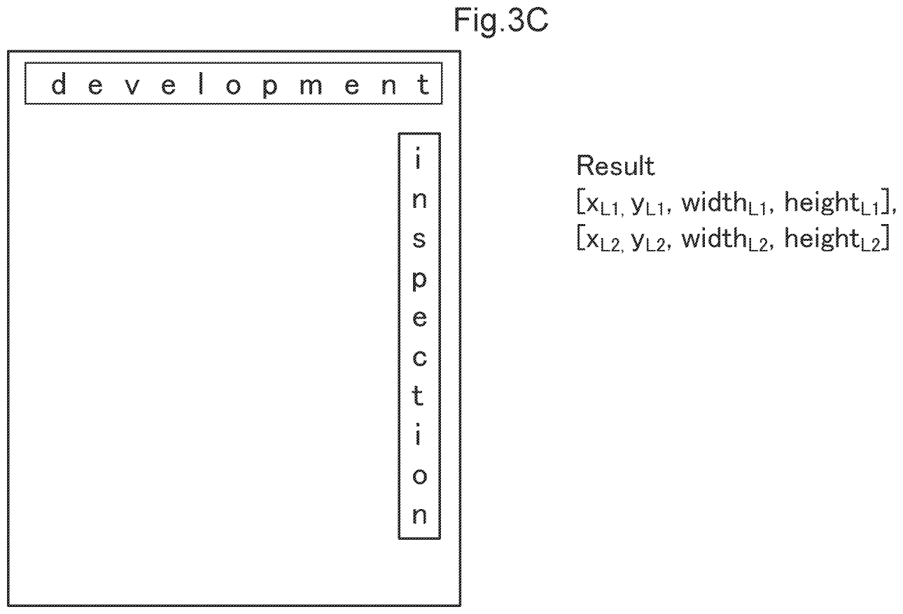

FIG. 3A illustrates an example of the digitized image, acquired through the image acquisition process 21. FIG. 3B illustrates an example of the layout of the characters detected through the character detection process 22a. FIG. 3C illustrates an example of positions of the lines detected through the line detection process 22b.

For example, when the digitized image shown in FIG. 3A is acquired through the image acquisition process 21, the characters and the respective positions thereof in the document contained in the digitized image are detected through the character detection process 22a, as shown in FIG. 3B. The position of each character in the document contained in the digitized image can be indicated, for example, by a coordinate (x, y) of a position in a rectangular region enclosing the character, such as the coordinate of an end portion of the rectangular region enclosing the character (e.g., upper left corner in FIG. 3B), and the width and the height of the rectangular region enclosing the character. However, the position of the character in the document contained in the digitized image may be indicated by a different method.

When the digitized image shown in FIG. 3A is acquired through the image acquisition process 21, the positions of the respective lines, each constituted of a plurality of characters, in the document contained in the digitized image, are detected through the line detection process 22b, as shown in FIG. 3C. The position of the line in the document contained in the digitized image can be indicated, for example, by a coordinate (x, y) of a position in a rectangular region enclosing the line, such as the coordinate of an end portion of the rectangular region enclosing the line (e.g., upper left corner in FIG. 3C), and the width and the height of the rectangular region enclosing the line. However, the position of the line in the document contained in the digitized image may be indicated by a different method.

As shown in FIG. 2, the main process 30 includes a character recognition process 31. The character recognition process 31 includes recognizing as far as what each of the characters, the position of which has been detected through the character detection process 22a, specifically represents, and identifying, according to the recognition, what specific characters are constituting the character string in each of the lines, the position of which has been detected through the line detection process 22b.

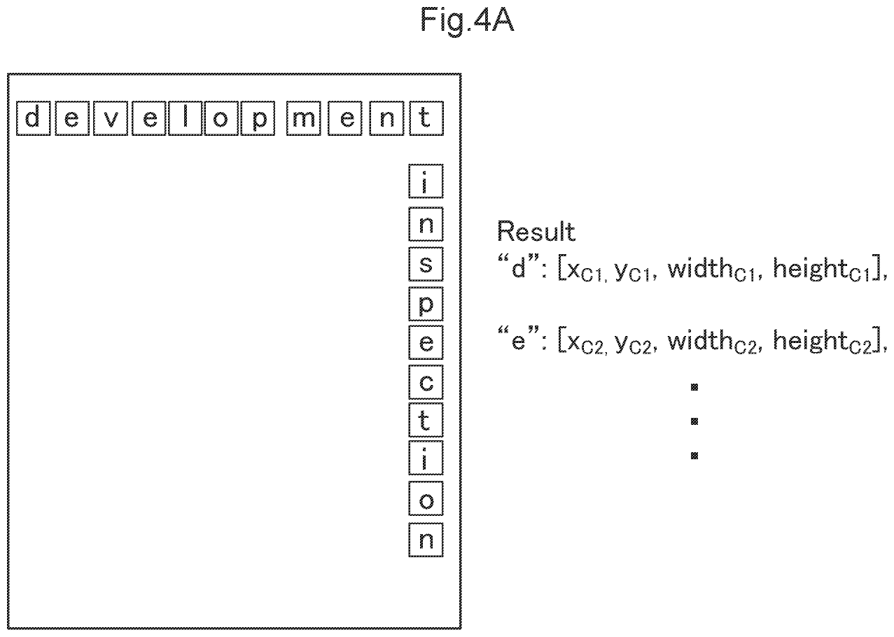

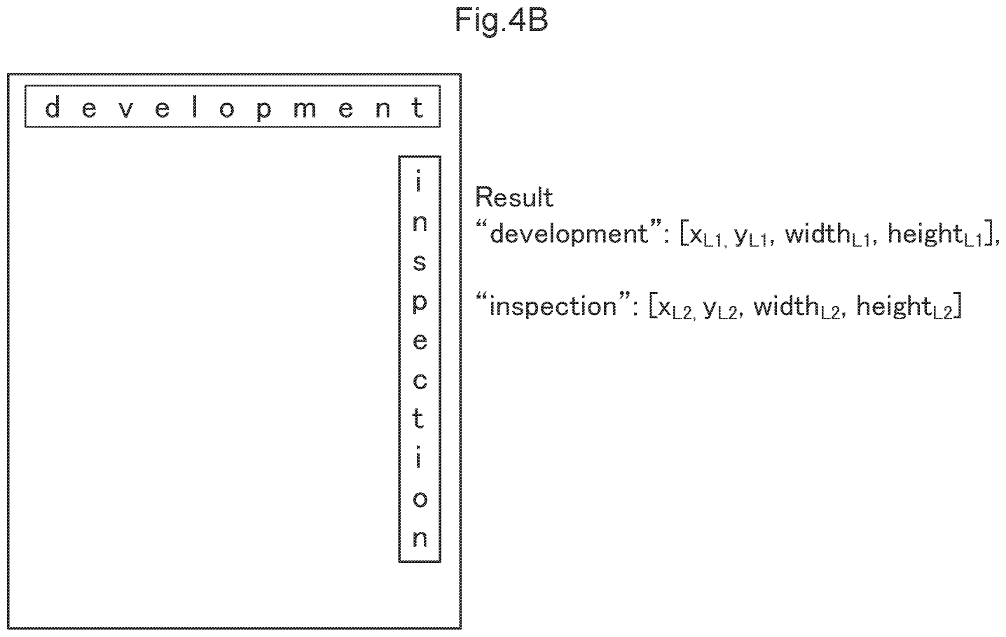

FIG. 4A illustrates an example of the characters recognized through the character recognition process 31. FIG. 4B illustrates an example of the character string of each line identified through the character recognition process 31.

For example, when the characters detected through the character detection process 22a are positioned as shown in FIG. 3, the character recognition process 31 is executed so as to recognize as far as what each of the characters in the document contained in the digitized image represents, as shown in FIG. 4A. In addition, when the lines detected through the line detection process 22b are positioned as shown in FIG. 3C, the character recognition process 31 is executed so as to identify as far as what characters are constituting the character string in each of the lines in the document contained in the digitized image, as shown in FIG. 4B.

As shown in FIG. 2, the postprocess 40 includes a knowledge process 41, including correcting misrecognition by the character recognition process 31, for example using the words included in a dictionary.

Thus, as result of sequentially executing the preprocess 20, the main process 30, and the postprocess 40, the OCR process by the image processing apparatus 10 is completed, so that the digitized image is converted into text data and the respective positions of the characters forming the text are detected. In the image processing apparatus 10, a learning process to be subsequently described is executed, to improve the accuracy of the character recognition by the OCR process. The data obtained through the learning process is utilized for the detection through the character detection process 22a and the line detection process 22b in the layout analysis process 22, and also for the recognition of the characters and the lines, through the character recognition process 31.

The OCR process executed by the image processing apparatus 10 also includes recognizing hand-written characters and generating the text data, on the basis of the digitized image. Accordingly, a learning process for improving the character recognition accuracy with respect to the hand-written characters will be described. Here, the control device 15 also acts as the hand-written pixel detection model learning device 15a, the blur correction device 15b, the character detection model learning device 15c, and the OCR device 15d, by operating according to the hand-written pixel detection model 14b and the character detection model 14c, in addition to the image processing program 14a, and the hand-written pixel detection model learning device 15a learns the hand-written character detection. Hereunder, the learning process of the hand-written character detection will be described.

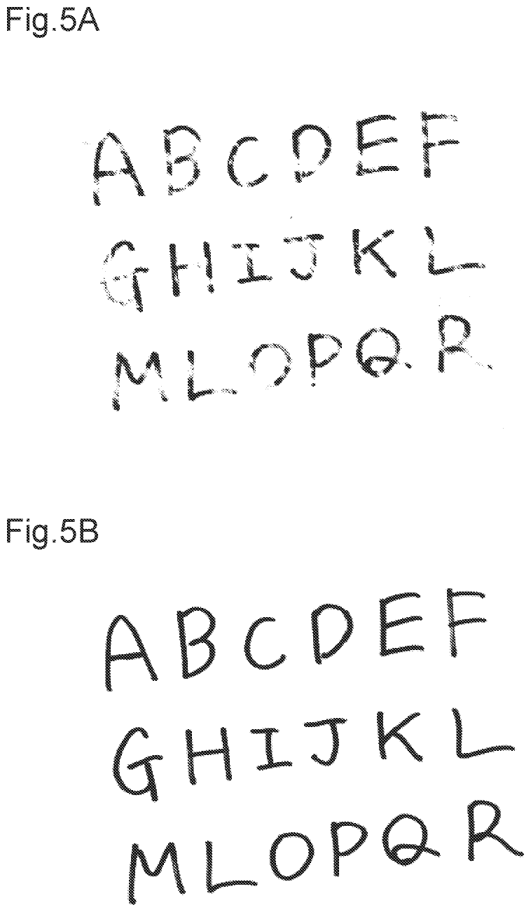

The operator prepares an image of a hand-written character having a blurred portion as learning data, and also an image of the same hand-written character free from the blur, as right answer data. FIG. 5A illustrates an example of the learning data used for the learning of the hand-written pixel detection model 14b. FIG. 5B illustrates an example of the right answer data used for the learning of the hand-written pixel detection model 14b.

The learning data shown in FIG. 5A is generated on the basis of the right answer data shown in FIG. 5B. The learning data shown in FIG. 5A may be generated by overpainting a portion of the pixel representing the hand-written character of the right answer data shown in FIG. 5B, for example with a white background color, either manually by the operator, or automatically with an image processing application.

The operator inputs the learning data and the right answer data to the image processing apparatus 10, for example from an external device through the communication device 13, or from the USB memory connected to the USB interface provided in the image processing apparatus 10. The operator then inputs a learning instruction of the hand-written pixel detection model 14b, in which the learning data and the right answer data are specified, to the image processing apparatus 10 via the operation device 11. When such instruction is inputted, the hand-written pixel detection model learning device 15a learns the hand-written character detection, using the learning data and the right answer data specified in the instruction.

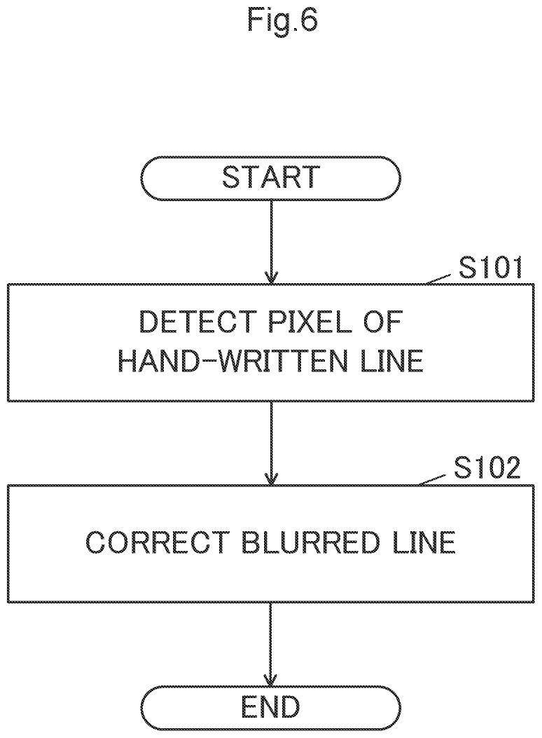

For the learning process of the hand-written character detection, the, blur correction process 21b is executed as the preprocess. FIG. 6 is a flowchart showing the blur correction process 21b executed by the image processing apparatus 10.

To execute the blur correction process 21b, the blur correction device 15b detects the pixel of the hand-written line included in the digitized image (S101).

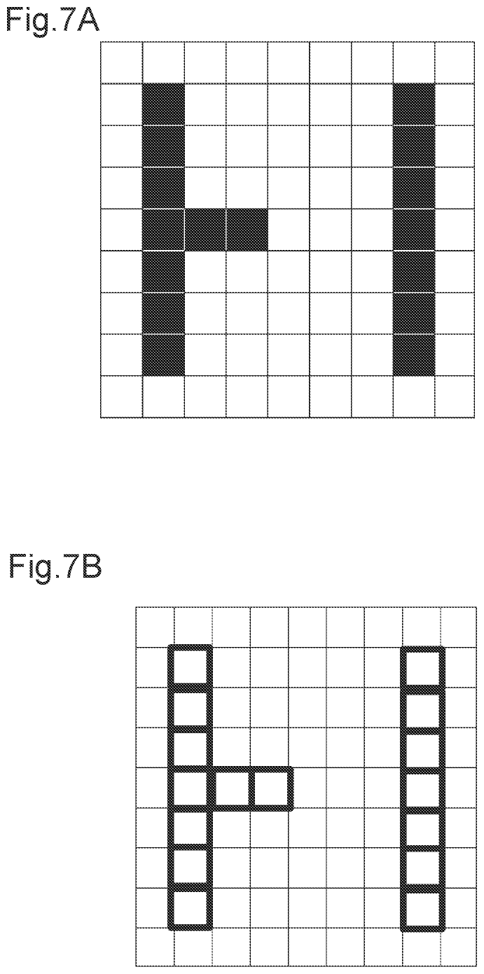

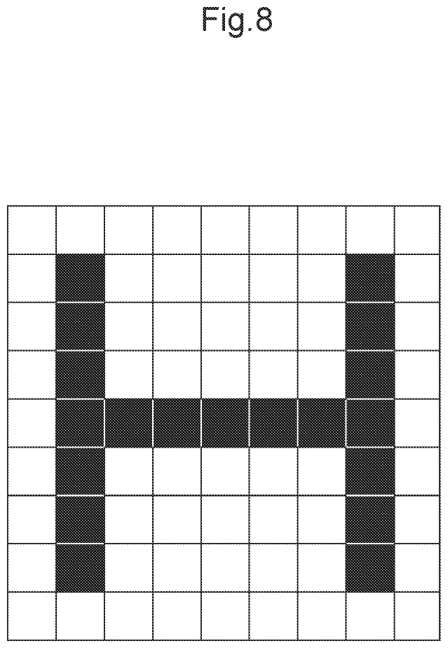

FIG. 7A illustrates an example of the digitized image, before the detection of pixels by the blur correction device 15b. FIG. 7B illustrates an example of the pixels detected by the blur correction device 15b.

The digitized image shown in FIG. 7A includes a character “H” with a blurred portion. The blur correction device 15b extrapolates the pixels surrounded by bold frames in FIG. 7B, as the pixels of the hand-written line, on the basis of the inputted digitized image shown in FIG. 7A, as the pixels representing the hand-written character “H”.

After S101, the blur correction device 15b corrects the blurred line included in the digitized image as shown in FIG. 8, by overpainting the pixels detected at S101 with a specific color such as black (S102). Thus, when the pixels shown in FIG. 7B are detected at S101, the blur correction device 15b generates the digitized image shown in FIG. 8, at S102. Thereafter, the operation shown in FIG. 6 is finished. FIG. 8 illustrates an example of the digitized image in which the blurred character has been corrected by the blur correction device 15b.

In the example shown in FIG. 7 and FIG. 8, the digitized image only includes a single hand-written character. However, the digitized image to be subjected to the blur correction process 21b may include a plurality of hand-written characters. In addition, the digitized image to be subjected to the blur correction process 21b may include a hand-written line other than the hand-written character, or an object other than the hand-written line. For example, the digitized image to be subjected to the blur correction process 21b may include at least one of a character other than the hand-written character, a ruled line other than the hand-written line, and a figure other than a hand-written figure. Further, although the digitized image to be subjected to the blur correction process 21b may be a color image, it is preferable that the blur correction process 21b converts the color image into a monochrome image, to alleviate the processing burden in the blur correction process 21b.

After the blur correction process, the hand-written pixel detection model learning device 15a executes the learning process of the hand-written character detection. The learning process of the hand-written character detection is executed by the hand-written pixel detection model learning device 15a, in a manner similar to the learning process of the character detection executed by the character detection model learning device 15c, which will be subsequently described.

In addition, the blur correction process 21b for the OCR process is also similarly executed, by the blur correction device 15b.

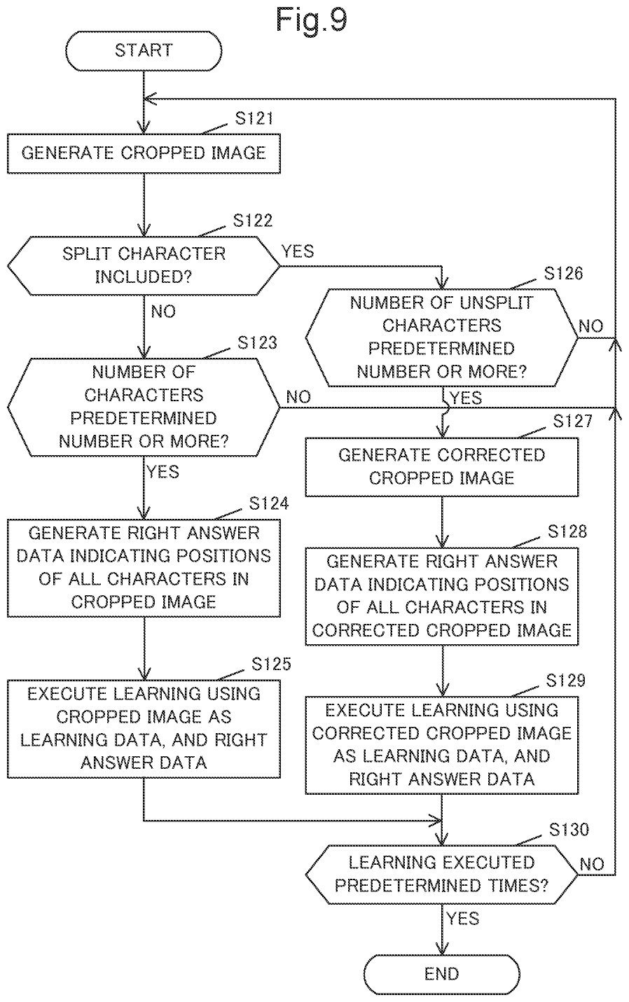

Hereunder, an operation executed by the image processing apparatus 10, for the learning process of the character detection, will be described. The learning process of the character detection is executed by the character detection model learning device 15c. FIG. 9 is a flowchart showing the operation executed by the image processing apparatus 10, for the learning of the character detection.

The operator prepares a digitized image of a specific size, for example the A4 size (“object image” in the subsequent description of the process according to FIG. 9), and right answer data indicating all the characters contained in the object image and the respective positions thereof (“object right answer data” in the subsequent description of the process according to FIG. 9), and inputs the object image and the object right answer data to the image processing apparatus 10, for example from an external device through the communication device 13, or from the USB memory connected to the USB interface provided in the image processing apparatus 10. The operator then inputs an instruction to execute the learning process of the character detection, in which the object image and the object right answer data are specified as the learning objects, to the image processing apparatus 10 via the operation device 11. When such instruction is inputted, the character detection model learning device 15c executes the process according to FIG. 9.

The character detection model learning device 15c generates an image formed by cropping the object image in a specific height and width from a specific position in the object image (hereinafter, “cropped image”) (S121). Here, although the specific height and width depend on the hardware resource of the image processing apparatus 10, the height and width may be, for example, 500 pixels×500 pixels.

When the learning process of the character detection is executed with respect to a large-sized image, for example the A4 size, as the learning data, the hardware resource of the image processing apparatus 10 may be exceeded because of the large data amount of the learning data, which may impede the normal execution of the learning process of the character detection. Accordingly, the character detection model learning device 15c crops a part of the large-sized image, and generates the image acquired by cropping, as the learning data having a smaller data amount.

After S121, the character detection model learning device 15c decides whether the cropped image generated at the immediately preceding step S121 contains an image representing a split character, on the basis of the object right answer data (S122). Here, the split character refers to a character, only a part of which is included in the cropped image generated at the immediately preceding step S121. The character detection model learning device 15c looks up, for example, a portion of the object right answer data corresponding to the cropped image generated at S121, and detects an image representing a character not contained in the portion of the object right answer data, as the image representing the split character.

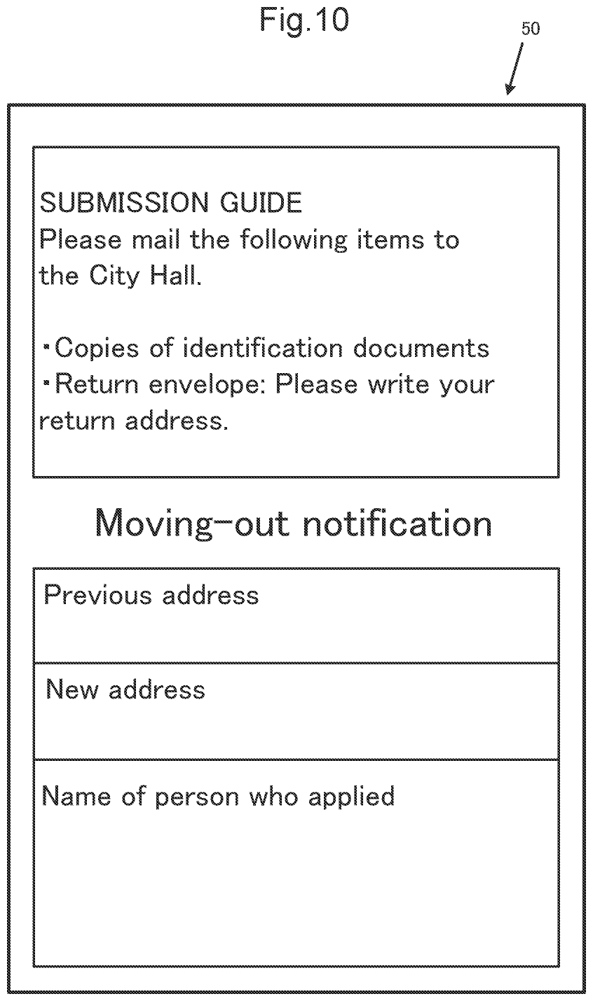

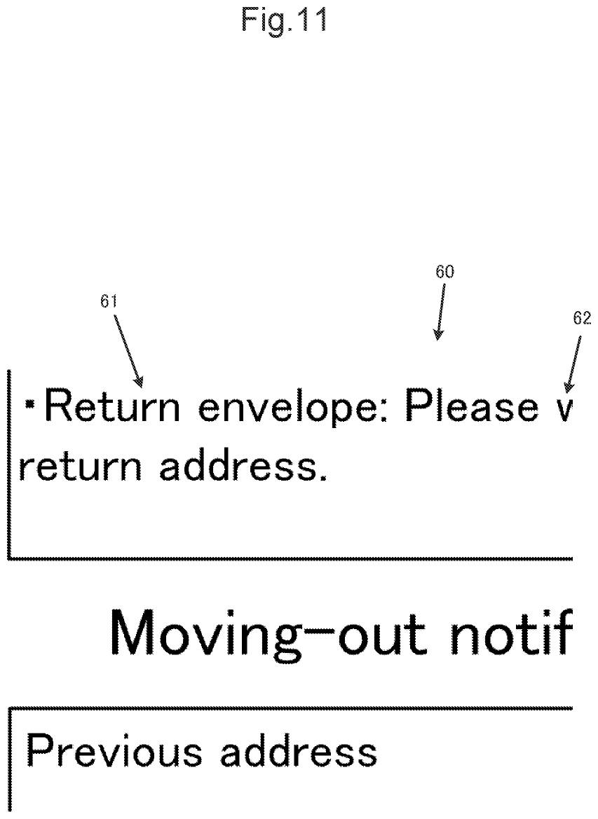

FIG. 10 illustrates an example of an object image 50 prepared for the learning of the character detection model 14c. FIG. 11 illustrates an example of a cropped image 60, generated through the operation of S121.

The cropped image 60 shown in FIG. 11 is generated from the object image 50 shown in FIG. 10. The cropped image 60 shown in FIG. 11 includes an image 61 representing the unsplit character (hereinafter, “unsplit character 61”), and an image 62 representing the split character (hereinafter, “split character 62”). In FIG. 11, the split character 62 corresponds to “W” shown in FIG. 10. Only the portion of “V”, out of the “W”, is included in the cropped image 60. The example of the cropped image 60 shown in FIG. 11 only includes a single split character 62. However, a plurality of split characters may be included in the cropped image.

Upon deciding at S122 that the cropped image generated at the immediately preceding step S121 does not contain the split character (NO at S122), the character detection model learning device 15c then decides whether the number of characters contained in the cropped image is equal to or larger than a predetermined number, on the basis of the portion of the object right answer data corresponding to the cropped image (S123).

Upon deciding at S123 that the number of characters contained in the cropped image generated at the immediately preceding step S121 is equal to or larger than the predetermined number (YES at S123), the character detection model learning device 15c generates the object right answer data, represented by the portion of the data corresponding to the cropped image, as the right answer data indicating the respective positions of all the characters contained in the cropped image (S124).

After S124, the character detection model learning device 15c executes the learning of the character detection model 14c, using the learning data, which is the cropped image generated at the immediately preceding step S121, and the right answer data generated at the immediately preceding step S124 (S125).

In contrast, upon deciding at S122 that the cropped image generated at the immediately preceding step S121 contains the split character (YES at S122), the character detection model learning device 15c then decides whether the number of images representing the unsplit character in the cropped image is equal to or larger than a predetermined number, on the basis of the portion of the object right answer data corresponding to the cropped image (S126). Here, the predetermined number referred to at S126 may be equal to the predetermined number referred to at S123.

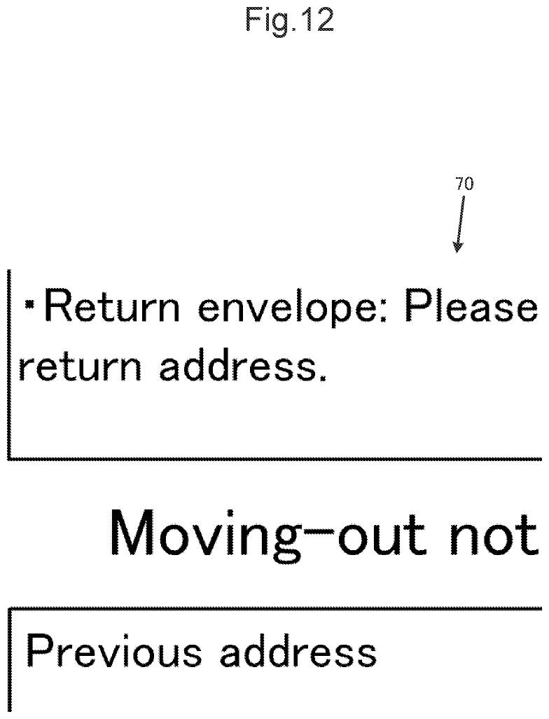

Upon deciding at S126 that the number of unsplit characters contained in the cropped image generated at the immediately preceding step S121 is equal to or larger than the predetermined number (YES at S126), the character detection model learning device 15c generates an image by removing from the cropped image the split character contained therein, as a corrected cropped image (S127). To be more detailed, the character detection model learning device 15c identifies the split character, the position thereof, and the region indicating the character, contained in the cropped image, on the basis of the portion of the object right answer data corresponding to the cropped image, and overpaints the split character with the background color of the cropped image, for example white, thereby generating a corrected cropped image 70 shown in FIG. 12.

The corrected cropped image 70 shown in FIG. 12 is generated from the cropped image 60 shown in FIG. 11. In the corrected cropped image 70, the split character 62 (see FIG. 11) is overpainted, for example with white.

After S127, the character detection model learning device 15c generates the object right answer data represented by the data portion corresponding to the corrected cropped image generated at the immediately preceding step S127, as the right answer data indicating the respective position of all the characters in the corrected cropped image (S128). Here, the right answer data generated at S128 by the character detection model learning device 15c does not include the split character and the position thereof, included in the cropped image generated at the immediately preceding step S121.

After S128, the character detection model learning device 15c executes the learning of the character detection model 14c, using the learning data which is the corrected cropped image generated at the immediately preceding step S127, and the right answer data generated at the immediately preceding step S128 (S129).

Then the character detection model learning device 15c decides whether the number of times that the learning process of S125, or the learning process of S129 has been executed has reached a predetermined number of times (S130).

Upon deciding at S130 that the learning has not been executed the predetermined number of times, according to the process of FIG. 9 (NO at S130), the character detection model learning device 15c again executes the operation of S121. In addition, upon deciding at S123 that the number of characters in the cropped image generated at the immediately preceding step S121 is fewer than the predetermined number (NO at S123), and upon deciding at S126 that the number of unsplit characters in the cropped image is fewer than the predetermined number (NO at S126), the character detection model learning device 15c also executes the operation of S121 again.

For the operation of S121 to be again executed, the character detection model learning device 15c generates a new cropped image different from the first generated one, from the object image. For example, the character detection model learning device 15c defines a plurality of regions by dividing the object image in a grid pattern, and generates the cropped image covering a different region, in each of the plurality of times of operations of S121. Then the character detection model learning device 15c executes the operation of S122 and the subsequent steps, with respect to the newly generated cropped image. The character detection model learning device 15c may generate the cropped images in a predetermined order from the plurality of regions, or in random order with respect to the plurality of regions. The character detection model learning device 15c does not generate the same cropped image twice, from the object image.

Upon deciding at S130 that the learning has been executed the predetermined number of times (e.g., the number of regions defined by dividing the object image in the grid pattern into a plurality of regions) according to the process of FIG. 9 (YES at S130), the character detection model learning device 15c finishes the current operation according to FIG. 9.

Here, a purpose of deciding at S123 whether the number of characters contained in the cropped image is equal to or larger than the predetermined number, and deciding at S126 whether the number of unsplit characters contained in the cropped image is equal to or larger than the predetermined number, is to effectively execute the learning of the character detection, by executing the learning using only the image containing the predetermined number or more of characters as the learning data. Accordingly, in the case where a slight degradation in effect of the learning of the character detection is permissible, the operation of S123 and S126 may be skipped. In other words, the character detection model learning device 15c may immediately proceed to S124, upon deciding at S122 that the split character is not contained in the cropped image generated at the immediately preceding step S121, or immediately proceed to S127, upon deciding at S122 that the split character is contained in the cropped image generated at the immediately preceding step S121.

As described thus far, the image processing apparatus 10 generates the learning data on the basis of the cropped image generated by cropping the image (S121 to S130). Therefore, a plurality of pieces of learning data can be generated from a single image, and consequently the detection accuracy of the position of the character by the character detection model 14c can be improved.

The image processing apparatus 10 does not adopt the cropped image containing the split character as the learning data (S129), but adopts the cropped image not containing the split character as the learning data (S125). Therefore, the cropped image containing the split character can be prevented from being utilized as the learning data, and consequently the detection accuracy of the character and the position thereof can be improved, in the recognition of the characters in the document contained in the image. For example, when the learning of the character detection model 14c is executed on the basis of the cropped image 60 shown in FIG. 11 as the learning data, the character detection model 14c that detects, instead of detecting “W” as one character, each of the two parts of “V” as one character, may be generated. However, since the image processing apparatus 10 generates the corrected cropped image 70 (see FIG. 12) as the learning data, by removing the part of “V” in the character “W” from the cropped image 60 shown in FIG. 11, the risk that each of the two parts of “V”, out of the character “W”, is detected as one character can be reduced.

Further, the image processing apparatus 10 adopts, when the split character is contained in the cropped image (YES at S122), the corrected cropped image in which the split character is removed from the cropped image, as the learning data (S127), thereby facilitating the generation of the learning data.

Here, in order to avoid adopting the cropped image containing the split character as the learning data, the image processing apparatus 10 may employ a different method from utilizing the corrected cropped image as the learning data. For example, when the split character is contained in the cropped image, the image processing apparatus 10 may newly generate a cropped image by changing at least one of the position, the shape, and the size in the object image.

In the foregoing description, only the blur correction process 21b is referred to, regarding the correction of the blurred character. However, the correction of the blurred character may be executed as the preprocess for the generation of the learning data of the character detection model 14c. More specifically, the image processing apparatus 10 corrects the blurred character before executing the operation of S121 to S130, and adopts the image in which the blurred character has been corrected as the object image, when executing the process according to FIG. 9. Thereafter, the image processing apparatus 10 (character detection model learning device 15c) executes operation of S121 to S130, using the image in which the blurred character has been corrected as the object image. In this case, the image processing apparatus 10 can generate the cropped image by cropping the object image in which the blurred character has been corrected (S121), when the object image contains the blurred character, and proceed to S122 and the subsequent steps. Consequently, the detection accuracy of the character and the position thereof by the character detection model 14c can be improved.

In the foregoing embodiment, the character detection model 14c is a module that only executes the character detection process 22a. However, the character detection model 14c may execute the process other than the character detection process 22a, in addition thereto. For example, the character detection model 14c may execute the line detection process 22b and the character recognition process 31, in addition to the character detection process 22a.

While the present disclosure has been described in detail with reference to the embodiments thereof, it would be apparent to those skilled in the art the various changes and modifications may be made therein within the scope defined by the appended claims.

What is claimed is:

1. A computer-readable, non-transitory recording medium having an image processing program stored therein,
the image processing program being configured to:
generate learning data of a character detection model that at least detects, to recognize a character in a document contained in an image, a position of the character in the image; and
cause a computer to:
generate a cropped image by cropping the image; and
adopt the cropped image not containing an image representing a split character as the learning data, instead of adopting the cropped image containing the image representing the split character as the learning data.

2. The recording medium according to claim 1,
wherein the image processing program is configured to further cause the computer to adopt, when an image representing the split character is contained in the cropped image, the cropped image free from the image representing the split character as the learning data, by removing the image representing the split character from the cropped image.

3. The recording medium according to claim 1,
wherein the image processing program is configured to further cause the computer to:
detect whether the image contains an image representing a blurred character;
correct, upon detecting the image representing the blurred character in the image, the detected image representing the blurred character into an image representing an exact character without the blur; and
generate the cropped image by cropping the image that has been subjected to the correction.

4. An image processing apparatus that generates learning data of a character detection model that at least detects, to recognize a character in a document contained in an image, a position of the character in the image,
the image processing apparatus comprising a control device including a processor, and configured to generate, when the processor executes an image processing program, a cropped image by cropping the image, and adopt the cropped image not containing an image representing a split character as the learning data, instead of adopting the cropped image containing the image representing the split character as the learning data.
